(19) United States
(12) Patent Application Publication
(10) Pub. No.: US 2018/0077914 A1
(43) Pub. Date: Mar. 22, 2018

(54) Flexible multi armed (match the hatch) flashing lure with the changeable weight to the rear

(71) Applicant: John Andrew Szoke, JR., Abbeville, SC (US)

(72) Inventor: John Andrew Szoke, JR., Abbeville, SC (US)

(21) Appl. No.: 15/731,038

(22) Filed: Apr. 10, 2017

Related U.S. Application Data
(63) Continuation-in-part of application No. 15/330,457, filed on Sep. 22, 2016.

(51) Int. Cl. A01K 91/053; A01K 91/04; A01K 85/00; A01K 95/02

(52) U.S. Cl. CPC A01K 91/053; A01K 95/02; A01K 85/00; A01K 91/04

(57) ABSTRACT

The invention relates to a fishing lure made up of an epoxy resin head where the fishing line will connect, a number of flexible stainless steel camouflage wire arms coming out the center backside of the head horizontally to create different width spreads on the lure. These flexible wire arms eventually bend downward 90 degrees to create the height of the lure, or the vertical arms with staggered lengths to them. A number of different baits can be attached to each individual arm. The flexibility of the wire arms allows adjustment of lure to keep its original shape. A center arm with multiple sized changeable weights to the far rear of invention, and the advantage of adding another bait on the end after the weight.

### FIELD OF INVENTION

The invention directly relates to a fishing device with multiple arms of flexible stainless steel wire to connect baits to, with a changeable weight to the rear center of lure.

### BACKGROUND ART

A fishing device with a number of items used for hooking and attracting fish. It can be made up of hooks, sinkers, lures, swivels, beads, and other tackle for fishing. For many decades a device with multiple rigged wire arms, with baits attached to each arm has been dragged at a distance behind a boat through the water to attracted and catch fish. this is the art of trolling with an umbrella rig. The rigidness of the wire arms telescoping outward from the center make it impossible to cast. I always thought a smaller multi armed lure that could be cast from a rod and reel should be made.

### SUMMARY OF INVENTION

The lure will have multiple flexible wire arms as stated in the title of the invention. There can be a three armed lure with two flexible outer arms and a flexible center arm which is the longest and makes up the third arm. There can be a five arm with four flexible outer arms and a flexible center arm which is the longest and makes up the fifth arm. There is also a seven arm with six flexible outer arms and a flexible center arm which is the longest and makes up the seventh arm.

All these flexible wire arms can be adorned on the ends with different baits to imitate a school of bait fish. When the last bait is attached to the longer center arm it makes the last bait look like it is trying to catch up to the others, a straggler, The center arm also plays a very important part. This arm has a changeable weight that can be adorned on the ends with different baits to imitate a school of bait fish. The seventh flexible arm which is the center arm is the longest. When the last bait on the center arm is attached it imitates a bait fish trying to catch up to the others, a straggler! The center arm also has a changeable weight so you can target the depth the fish are at, and the weight being at the far rear of the lure makes this lure a joy to cast and tangle free. The weight is already facing the way you are casting it does not have to turn over in mid air as the ones with the weight to the front at the head. The whole point of this invention because of the spread, and stagger of arms, and the weight to the far rear is to keep the lure tangle free. Less tangles more time fishing.

### DETAILED DESCRIPTION OF DRAWINGS

A multi armed fishing lure with flexible horizontal wire arms telescoping outward from the rear center of the epoxy head to create the spread on the lure to keep baits separated.

After a short distance the arms turn downward to make up the vertical arms with a stagger in them to keep baits separated from each other when casting and retrieving lure. The flexible wire lets you keep lure in its originnal shape and to reshape whenever needed

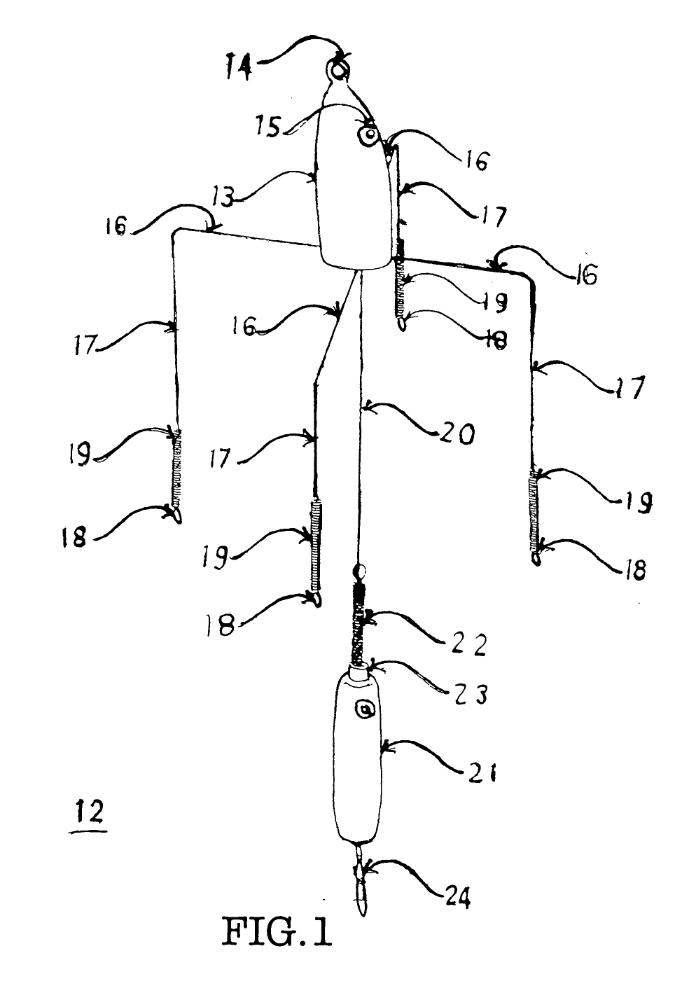

FIG. 1. Shows straight up view of five arm lure invention with the changeable weight to the rear.

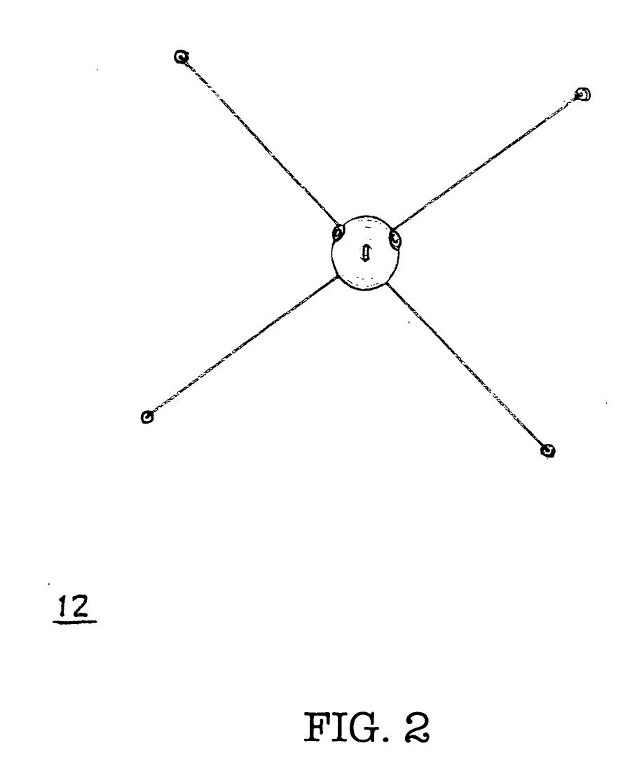

FIG. 2. Shows frontal view of five arm lure invention.

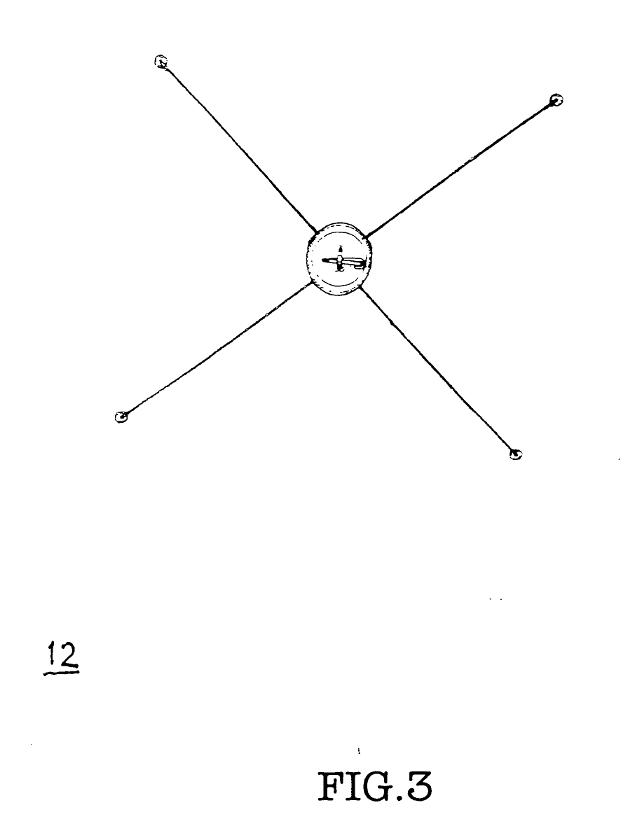

FIG. 3. Shows tail end view of five arm lure invention.

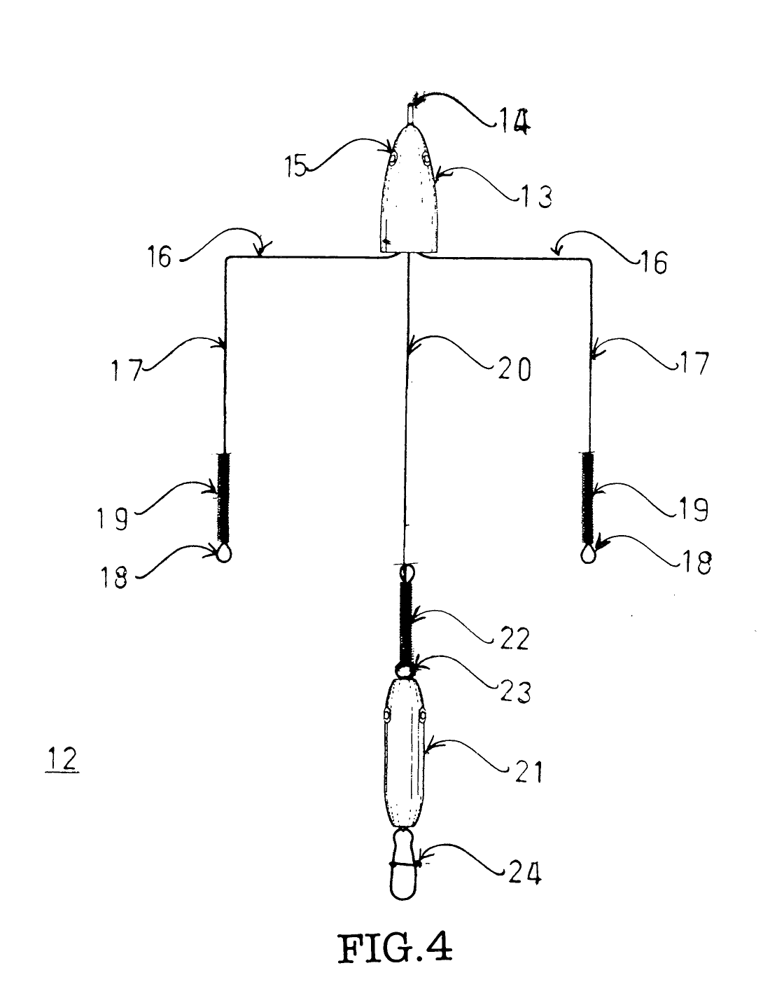

FIG. 4. Shows straight up view of three arm lure invention.

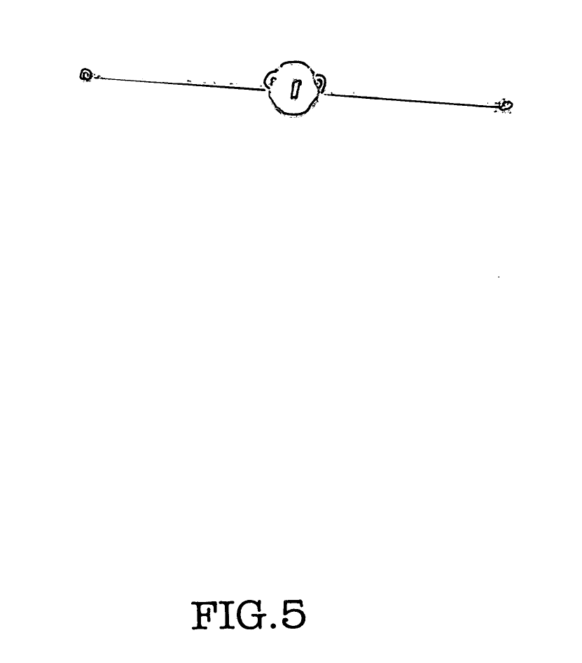

FIG. 5. Shows frontal view of three arm lure invention.

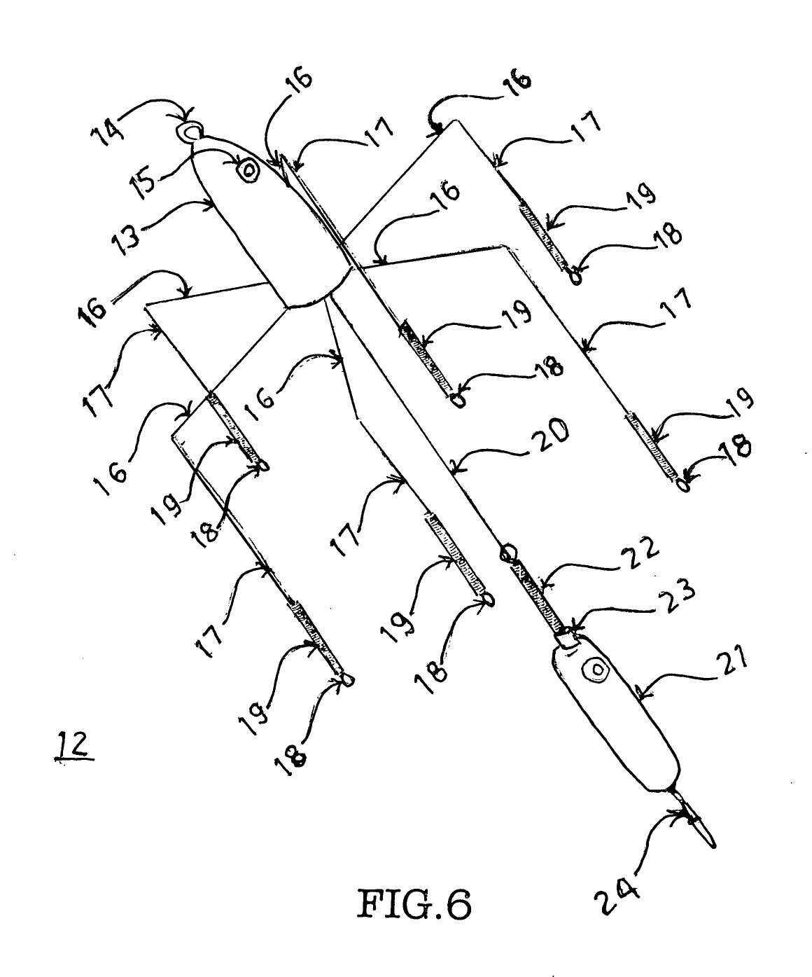

FIG. 6. Shows angled view of seven arm lure invention.

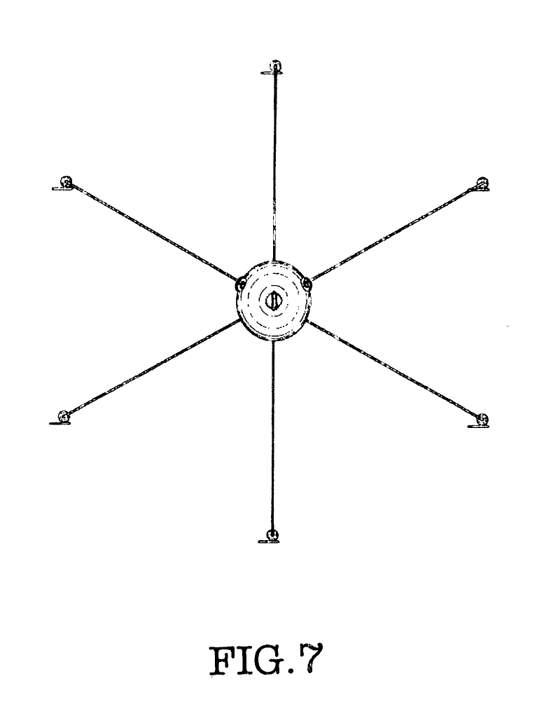

FIG. 7. Shows frontal view of seven arm lure invention.

### SPECIFICATIONS OF INVENTION

The fishing lure invention will be number 12. The head 13 that is made out of epoxy resin that bounds and encapsulates all the flexible stainless steel wire arms, and is lighter in weigh. This is the first important factors of this invention less weight in the front and all the weight in the rear makes casting and retrieving the lure tangle free. Head 13 will also be painted to imitate bait fish, have holographic eyes 15 and an eyelet 14 in the front to connect lure 12 to line from fishing pole. At the back of head 13 there are multiple flexible stainless steel arms 16 that make up the important horizontal spread on lure. The spread would be from 1½ inches to 3 inches in a 1/2 inch increment graduation depending on lure type. These horizontal arms telescope outward from the back center of head 13 to there various distance depending on lure type, then makes a 90 degree turn downward to form the vertical arms 17 on lure. The horizontal spread on lure invention is the second important factor about this invention. The spread from the back center of head outward each way keep swim baits separated from each other and tangle free. Vertical arms 17 will have a stagger in them, with the measurements that follow. A lure 12 that will have 1½ inch swim baits attached to the end of arms has a 1½ inch stagger in the vertical arms 17. Every other arm would be 1½ inch longer or shorter to create the stagger. Depending on which lure 12 type, the stagger will increase in ½ inch increments up to 5 inches on the biggest model made. The stagger in the vertical arms 17 is the third important factor about this invention. The stagger keeps the baits vertically away from each other and tangle free, Vertical arms 17 will also be of different starting lengths after the 90 degree bend, not including the staggers depending on swim bait lengths. All the arms are made out of 0.024 to 0.051 thousands thick stainless steel camouflage wire and a formed eyelet 18 at the end with a coiled stainless steel spring 19 to hold them closed and to open them. This spring allows the fisher person to quickly change to the bait needed to match size, color, and shape of bait fish present at that time. (MATCH the HATCH) Slide spring up arm to open, push down to close. This is the forth important factor about this invention.

Center arm 20 connects all the flexible horizontal arms 16 to a coil formed on the upper end of the arm. Then epoxy resin is casted around them to bound them together and form the head 13. Center arm 20 also forms the eyelet 14 at the front of head 13, and to the far rear also holds on the different sized changeable weights 21 (from ¼ ounces to 4 ounces), and connects the last swim bait which is changeable too. With this weight 21 being at the very end of lure 12 the fisher person will not have to deal with line wrap around the vertical arms 17. The weight 21 is already facing the way you are casting. This is the fifth important factor of invention On other multiple arm lures with the weight being in the front when you cast the lure has to turn over in flight wrapping the arms. There is a stainless steel weight retaining spring 22 on center arm 20 with a bead 23 that holds tension on weight 21 when different size weights 21 are used. The pressure also pushes against the snap 24 at back of lure 12 which does two things. First: open and take off snap 24 to remove and change size of weight 21 then replace snap to hold new weight 21 on. Second: The snap 24 also connects the center swim bait to lure 12. Center arm 20 also has a stagger. It will be 1½″ to 5″ longer in ½″ increments than the longest vertical arm 17 depending on size of swim baits. This keeps the center bait separated and tangle free, and is the sixth important factor of this invention.

What is claimed:

1. A cast-able fishing invention with light weight epoxy resin head that connects fisher persons line from pole. The resin also encapsulates and bounds all the flexible wires that form a horizontal spread from back center of head to keep baits separated horizontally. Then on outward 1½″ to 3″ depending on lure type be bent downward 90 degrees to create vertical arms with a stagger to keep baits separated. On which baits will be attached to the end of all arms to create a school of bait fish with an extended center trailing bait fish trying to catch up to the others on the center arm. This center arm also holds the interchangeable weight of many sizes, and keeps weight of fishing invention far to the rear for easy and tangle free casting.

2. The cast-able fishing invention of claim 1. that has a head made of light weight epoxy resin.

3. The cast-able fishing invention of claim 1. that have multiple arms made of flexible stainless steel camouflage wire from 0.024 to 0.051 thousands in diameter.

4. The cast-able fishing invention of claim 1. all flexible wire arms are bound securely in epoxy resin head.

5. The cast-able fishing invention of claim 1. has an eyelet at the end of each flexible wire arm with a sliding stainless steel spring for easy on and off with baits.

6. The cast-able fishing invention of claim 1. all arms first have a horizontal spread from back center of head projecting outward north, south, east, and west to keep baits separated and tangle free.

7. The cast-able fishing invention of claim 1. all arms after horizontal spread turn vertical and have a long & short stagger to keep baits separated and tangle free.

8. The cast-able fishing invention of claim 1. has a weight that is easily changeable and of many different sizes to reach your desired depths.

9. The cast-able fishing invention of claim 1. has the changeable weight far to the rear on center arm instead of at the head to eliminate line wrap when casting. The weight is facing the way you are casting.

10. The cast-able fishing invention of claim 1. has a center arm that is the longest of all arms and also has its own additional stagger to keep baits separated and tangle free.

11. The cast-able fishing invention of claim 3. can have two flexible outer arms and a center arm in the middle which is the longest. This is the three arm of the multiple armed lure invention.

12. The cast-able fishing invention of claim 3. can have six flexible outer arms and a center arm in the middle which is the longest. This is the seven arm of the multiple armed lure invention.
